(19) United States
(12) Patent Application Publication
(10) Pub. No.: US 2009/0078615 A1
(43) Pub. Date: Mar. 26, 2009

(54) Sluice assembly for separating heavy particles from slurry

(76) Inventors: Chuck Rainwater, Salome, AZ (US); Matthew Rainwater, Salome, AZ (US)

Correspondence Address: RUSSO & DUCKWORTH, LLP, 2nd Floor, 9090 Irvine Center Drive, Irvine, CA, 92618, US

(21) Appl. No.: 11/903,015

(22) Filed: Sep. 20, 2007

(51) Int. Cl. B07B 9/00

(52) U.S. Cl. 209/44; 209/682

(57) ABSTRACT

A sluice assembly for separating heavy particles from slurry is provided. The sluice assembly includes one or more sluice boxes having decks made of plastic having a Shore D hardness between 50-75, a static coefficient of friction less than 0.3 and a kinetic coefficient of friction less than 0.2. In a preferred embodiment, the sluice assembly includes a pair of sluice boxes in which a top sluice box is positioned above the bottom sluice box so that slurry flowing from the downstream end of the first sluice box is received by the upstream end of the bottom sluice box. The bottom deck includes tapered riffles which are arranged to provide “V” shaped diverters for diverting heavier particles for collection. The sluice box upper deck may include laterally extending riffles for collection of heavier particles.

### BACKGROUND OF THE INVENTION

The present invention relates to mineral and gemstone mining. More particularly, the present invention relates to sluice assemblies for recovering precious metal deposits and gemstones from a slurry mixture of water and mineral ore.

Wet placer mining has been employed for centuries for separating metals, particularly gold, platinum, and gemstones from rock and sand constituents. Conventionally, various apparatus are utilized for concentrating or separating mineral or gemstone containing materials. The most basic construction includes the use of a gold pan. In use, a slurry mixture is placed in the gold pan and a mixture of gravity, agitation and flotation is employed to cause heavier gold particles to sink to the bottom of the pan while lighter materials are caused to flow out of the pan. Since the pan is typically handled manually, its size limits the amount of material that can be processed. Furthermore, panning is a tedious and manually strenuous process.

Another apparatus used for wet placer mining includes sluice assemblies. Early sluice assemblies were wooden troughs constructed with crossbars or riffles which allowed the gold to be trapped against the riffles. Controlled agitation was imparted to the sluice box which caused water to be displaced over the riffles to progressively leave behind heavier mineral matter. Various types of movements have been employed to the sluice boxes for the purpose of collecting minerals of different relative density, also referred to as specific gravity, in order to retain the desired mineral matter.

A very wide range of designs for sluice assemblies have been developed or proposed over the years. Most of these designs include a trough or receiving pan for receiving a slurry of ore and water which is moved by vibration or the influence of water. Sometimes the trough includes separating grids for allowing mineral particles of a smaller size to fall through the grids to a lower level for further processing. Larger rocks and larger particulate matter are ejected from the sluice assembly for disposal or processing into smaller particulates which may be fed back into the receiving pan. In addition to the use of riffles to concentrate heavier minerals and gemstones, it has been common to place a mat of carpet or synthetic fiber adjacent to the riffles to trap minerals. The mats are typically removable from the sluice assembly to allow manual or automated removal of particulates trapped within the carpet fibers.

In addition to the basic sluice assembly described above, numerous patents have been issued reflecting a wide range of sluice box constructions. As early as the 1830s, ore washers were used for separating minerals from ore. Early U.S. Pat. Nos. 73,160; 1,588,102 and 1,752,169 illustrate mineral separators which include wire screens for gravity separation of heavier materials. The implementation of burlap or carpet to trap finer and denser materials are also described within U.S. Pat. Nos. 157,192 and 386,030.

More recently, various sluice assemblies have been developed for mobility and devised to include wheels and hitches for facilitating transportation. Gas powered motors connected to linkage devices are described in various patents including within U.S. Pat. Nos. 3,682,304 and 4,860874. Unfortunately, the use of motors to impart oscillation to the sluice box can result in unwanted vibration to the entire assembly thereby resulting in undesirable damage to the sluice assembly.

An excellent design for constraining vibration to the sluice box and minimizing its effects to the remaining assembly is described in U.S. Pat. No. 6,308,835 naming Darvin Wade as the inventor. This patent describes a sluice assembly including a pair of sluice boxes which are pivotally connected in which movement of a sluice box in one direction causes the other sluice box to move in an opposite direction. Overall, this construction enables the sluice assembly to have a center of gravity which undergoes little movement.

Unfortunately, the various sluice assemblies suffer from various drawbacks. Foremost, sluice assemblies are not particularly efficient resulting in substantial amounts of sought-after mineral and gemstones being swept away by the flowing water or removed with the unwanted processed ore. Furthermore, sluice assemblies can be complicated and expensive to manufacture and transport.

Accordingly, there exists a need to provide an improved sluice assembly which provides for increased efficiency, while at the same time reducing manufacturing and transportation costs.

### SUMMARY OF THE INVENTION

Briefly, in accordance with the invention, an improved sluice assembly for mining precious metals and minerals is provided. The sluice assembly preferably includes two sluice boxes. Each sluice box includes a sloping deck having an upstream end for receiving a slurry and a downstream end for expelling a slurry. Preferably, the sloping decks include sidewalls for directing a slurry in the desired direction of flow.

In a preferred embodiment, the sluice assembly includes an actuator for oscillating each sluice box in a reciprocating upstream and downstream motion. To this end, preferably the sluice assembly includes a frame as well as a plurality of linkages for connecting the first sluice box positioned above the second sluice box. The linkages connect each sluice box in a manner in which movement of the first sluice box in an upstream or downstream direction causes the second sluice box to move in an opposite direction.

To impart motion to the sluice boxes, the sluice assembly preferably includes a fuel or electric driven motor which imparts movement to the first or second sluice box using axial, gear or belt drives as can be selected by those skilled in the art. In additional embodiments, the actuator for imparting movement to the sluice boxes may be water powered.

In a preferred embodiment, the sluice box decks are made of plastic having a Shore D hardness between 50-75 and a static coefficient of friction less than 0.3 and a kinetic coefficient of friction less than 0.2. These coefficients of friction are determined by application of standard ASTM-D1894 for plastics against steel. More preferably, the sluice box decks are made of a plastic having a Shore D hardness between 64-70, and have frictional properties in which the static coefficient of friction is less than 0.26 and a kinetic coefficient of friction of less than 0.15 as determined by ASTM-D 1894. Only a limited number of known plastics can be employed as sluice decks which would conform with these hardness and frictional properties. Acceptable plastics include certain ultra high molecular weight (UHMW) plastics. Moreover, Tivar®, including but not limited to Tivar® 1000 and Tivar® Dryslide, made by Quadrant EPP is considered ideal.

In additional preferred embodiments, the sluice boxes employ unique riffle constructions. In a preferred embodiment, the second “lower” sluice box includes riffles which project upward from the sluice box deck and which are positioned to form a plurality of “V” shaped diverters for diverting the heavier particles within the slurry to desired locations. More specifically, the riffles are positioned to form “V” shaped diverters in which the open end of the “V” is directed to the upstream end of the deck and narrow end of the “V” is positioned toward the downstream end of the deck. The term “V shaped” is intended to be interpreted relatively broadly to include similar tapered constructions in which riffles are positioned with a wide open end and the “V” shaped diverters taper to a narrow end which is positioned toward the downstream end of the deck.

Moreover, the “V” shaped diverters preferably include an opening at their narrow ends for allowing heavier materials to pass through the diverter to additional “V” shaped diverters. Preferably, the lower sluice box deck also includes one or more holes positioned immediately downstream of the “V” shaped riffles so that heavier particles which are diverted by the “V” shaped diverters then pass through the holes for collection. Preferably, the riffles forming the “V” shaped diverters have a height sufficient to divert particles having a predetermined specific gravity or greater toward and into the deck holes for collection. Also preferably, the riffles are sufficiently low so that lighter particles within the slurry can pass over the riffles so as to not be diverted by the “V” shaped diverters and thus avoid collection.

Preferably, the upper deck also includes riffles which are sized and positioned for accomplishing specific tasks. In a first preferred embodiment, the deck includes a plurality of riffles which are positioned to extend laterally and at an angle to the flow of slurry. The riffles are sized to allow slurry carrying the minerals and gemstones to flow above and around the riffles to create turbulence in the slurry flow in an effort to mix the mineral ore into a liquid suspension. The angled and laterally extending riffles may direct heavy materials to certain locations at the downstream end of the deck for being expelled to the lower second sluice box.

In an alternative embodiment, the top sluice box includes a top deck having riffles that extend directly laterally, at a 90° angle, to the direction of flow of the slurry traveling down upon the top deck. Instead of being provided only for creating turbulent flow and for directing heavy materials to desired portions of the bottom deck, the laterally extending riffles are sized to capture and collect heavier materials. More specifically, materials too heavy to pass over the riffles are captured at the intersection of the top deck and the riffles where they can be manually or mechanically collected. In a preferred embodiment, the laterally extending riffles have a rectangular cross-section and a height of 1″ and a thickness of 1½″. Depending on slurry flow, this construction is ideal for collecting diamonds which have a specific gravity greater than 3.

The riffles may be made of various materials. However, in a preferred embodiment the riffles are made of the same material as the top deck and have a Shore D hardness between 50-75, a static coefficient of friction of less than 0.3 and a kinetic coefficient of friction less than 0.2. More preferably, the riffles are also made of UHMW plastic such as a Tivar® plastic having a Shore D hardness between 64-70, and a coefficient of friction less than 0.26 and a kinetic coefficient of friction less than 0.15. Again, all coefficients of friction described herein are calculated in accordance with ASTM-D 1894.

Thus, it is an object of the present invention to provide a sluice assembly which more efficiently collects precious minerals and gemstones than prior sluice assemblies.

It is still an additional object of the invention to provide a sluice assembly which is lightweight.

Moreover, it is an object of the present invention to provide a sluice assembly that is inexpensive to manufacture, requires little maintenance, and is easy to operate.

These and other more specific objects and advantages of the invention will be apparent to those skilled in the art from the following detailed description in conjunction with the drawings.

### BRIEF DESCRIPTION OF THE DRAWINGS

FIG. 1 is a perspective view of the sluice assembly of the present invention including a feed pan;

FIG. 2 is a perspective view of the sluice assembly of the present invention without a feed pan;

FIG. 3 is a perspective view of the frame and actuator assembly employed within the sluice assembly of the present invention;

FIG. 4 is a perspective view illustrating the shaft connection for oscillating the sluice boxes of the present invention;

FIG. 5 is a side view illustrating the motor and shaft connections for oscillating the sluice boxes of the present invention;

FIG. 6 is a perspective view illustrating a preferred embodiment of a top deck for use with the sluice assembly of the present invention;

FIG. 7 is a perspective view illustrating a second preferred embodiment of a top deck for use with the sluice assembly of the present invention;

FIG. 8 is a perspective view illustrating a first preferred embodiment of a bottom deck for use with the sluice assembly of the present invention;

FIG. 9 is a perspective view illustrating a second preferred embodiment of the bottom deck for use with the sluice assembly of the present invention;

FIG. 10 is a side view of the sluice assembly of the present invention;

FIG. 11 is a side view of the sluice assembly of the present invention in which the sluice boxes have been oscillated to an upstream position;

FIG. 12 is a side view of the sluice assembly of the present invention in which the sluice boxes have been oscillated to a downstream position;

FIG. 13 is a side cutaway view of an embodiment of the top deck including laterally extending riffles; and

FIG. 14 is a side cutaway view illustrating a nugget trap positioned adjacent to the top sluice box.

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention and it is not intended to limit the invention to specific embodiments illustrated.

With reference to the figures, the sluice assembly 1 of the present invention includes at least one sluice box, and preferably includes two sluice boxes referred to herein as a top sluice box 23 and a bottom sluice box 47. The top sluice box 23 includes a sloping deck 25 defining an upstream end 27 and a downstream end 29. Preferably, the sluice box further includes sidewalls 31 as well as riffles 33. Similarly, the bottom sluice box 47 includes a sloping bottom deck 49 defining an upstream end 51 and a downstream end 53. As shown, the bottom sluice box further includes sidewalls 55 as well as riffles 33. Preferably, both the top deck and bottom deck of the sluice assembly have a slope of approximately 1″-1½″ per foot.

The decks of sluice boxes have long been made of metal or wood. Conversely, it has been discovered that it is much preferred that the sluice box decks of the present invention be made of a plastic material for providing lightweight, low cost, and better resistance against environmental conditions. However, to adequately function in the efficient separation of heavier particles from a slurry, it is preferred that the decks have a Shore D hardness between 50-75. Furthermore, it has been determined that to provide efficient separation of heavier minerals and gemstones, it is preferred that the sloping decks have a static coefficient of friction of less than 0.3 and a kinetic coefficient of friction less than 0.2. Each of these coefficients of friction are determined in accordance with standard ASTM-D 1894. Even more preferable, it is preferred that the sluice box decks be made of a plastic having a Shore D hardness between 64-70 and an ASTM-D 1894 calculated static coefficient of friction less than 0.26 and a kinetic coefficient of friction less than 0.15. Only a limited number of plastics are capable of providing these engineering properties. Certain ultra high molecular weight (UHMW) plastics may be utilized. Meanwhile, it has been determined that Tivar® plastic, including Tivar® 1000 and Tivar® dryslide, is an ideal material for use as sluice box decks in the sluice assembly of the present invention.

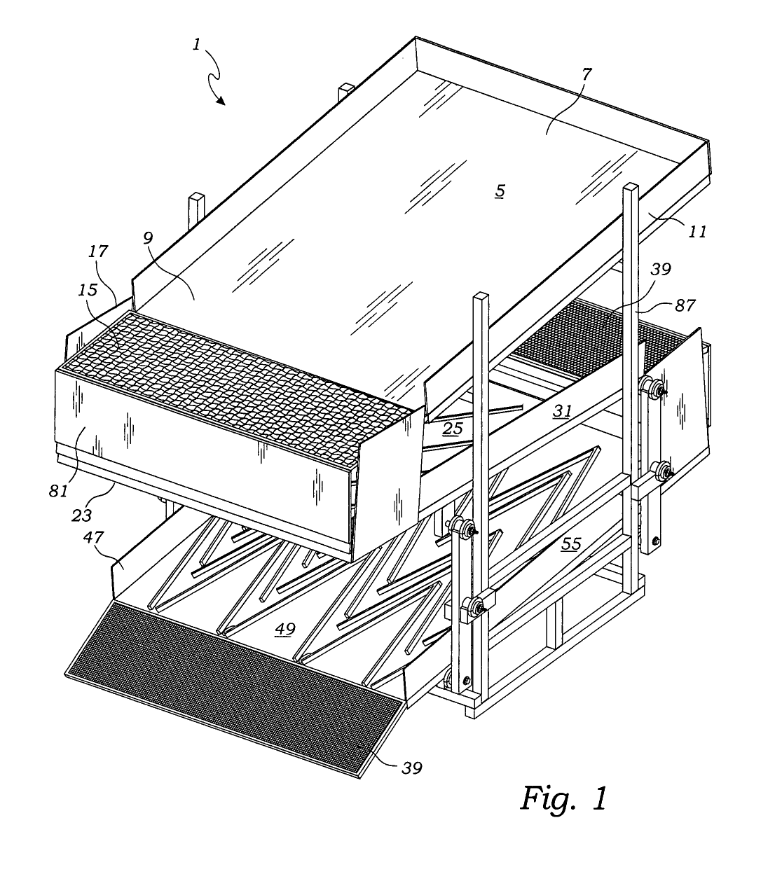

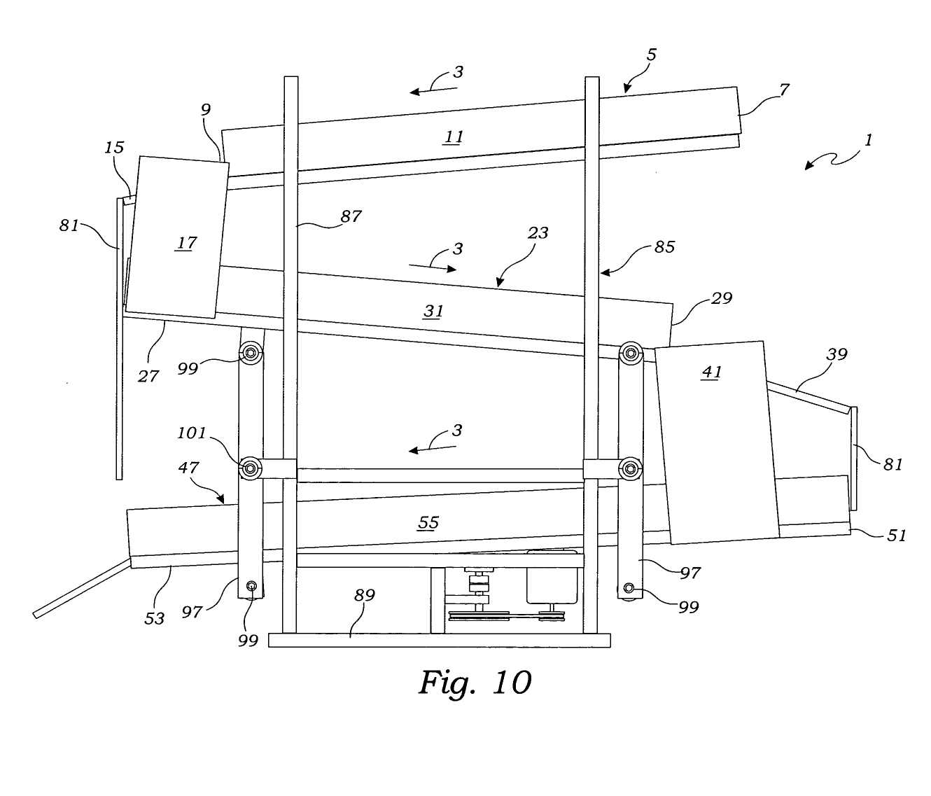

As illustrated in the figures, the top sluice box 23 is positioned above the bottom sluice box 47 so that the slurry that flows off the downstream end 29 of the top sluice box falls and lands upon the upstream end 51 of the bottom sluice box 47. Preferably, as shown in FIGS. 1 and 10-12, the sluice assembly 1 also includes a feed pan 5 positioned above the top sluice box 23 for receiving a slurry prior to processing. The feed pan 5 also includes an upstream end 7 and a downstream end 9, as well as sidewalls 11 for directing a slurry to a classifying screen 15. Preferably, the sidewalls 17 are also positioned on each side of the classifying screen 15 so as to prevent the slurry from being expelled from the sluice assembly. If a first classifying screen 15 is employed, it may include various mesh sizes. However, in a preferred embodiment the mesh holes are relatively large such as between ¼″-2″ in length and width. As seen in the figures, the sluice assembly may further include a second classifying screen 39 which is positioned immediately downstream from the top sluice box deck. Preferably, this second classifying screen 39 has a mesh size much smaller than the initial classifying screen 15. Preferably, the second classifying screen 39 has a mesh size of 4-12 corresponding to a hole size of ¼″- 1/12″ in length and width.

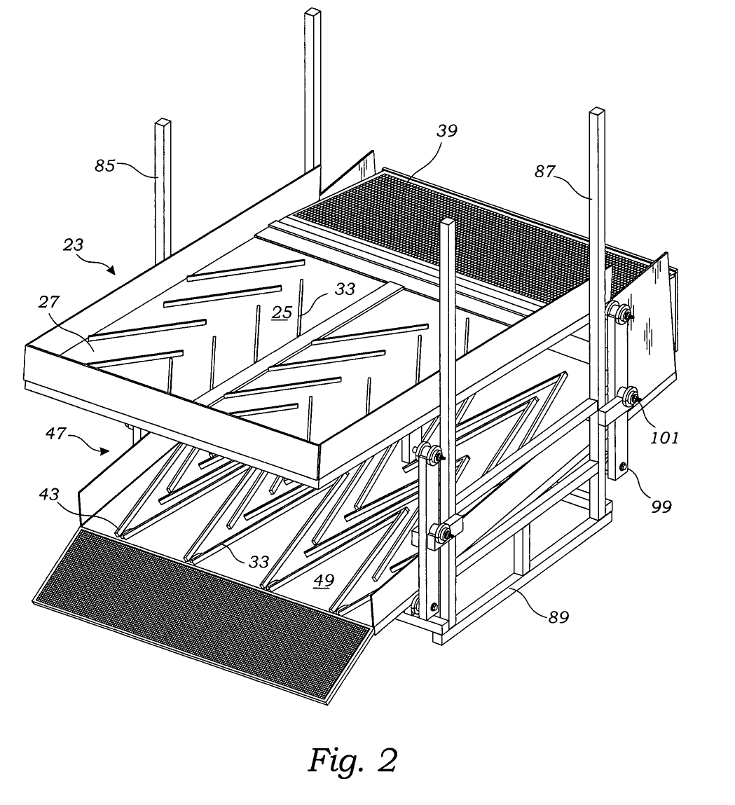

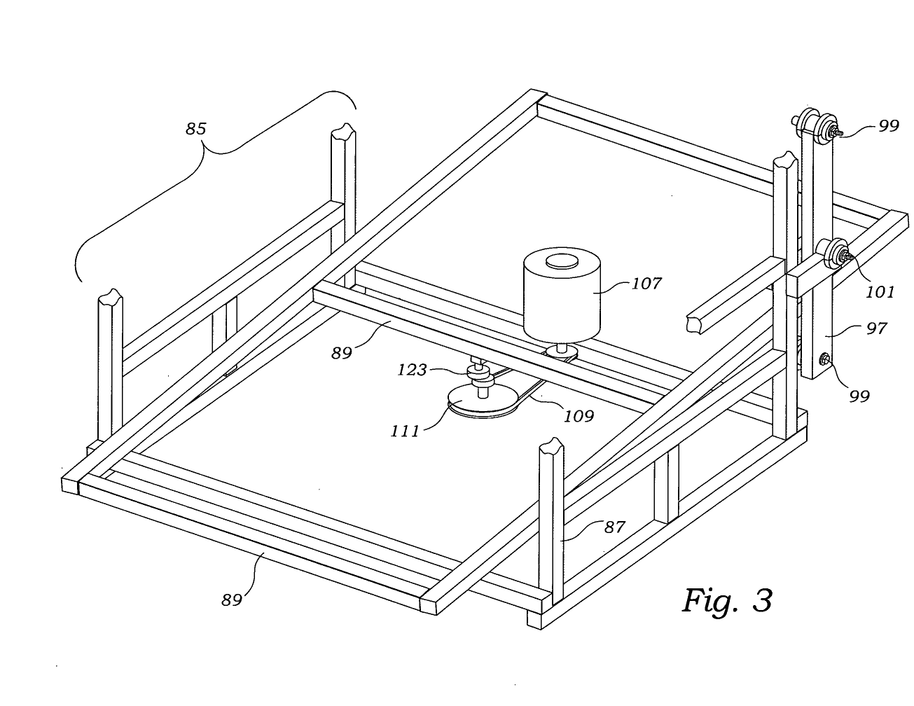

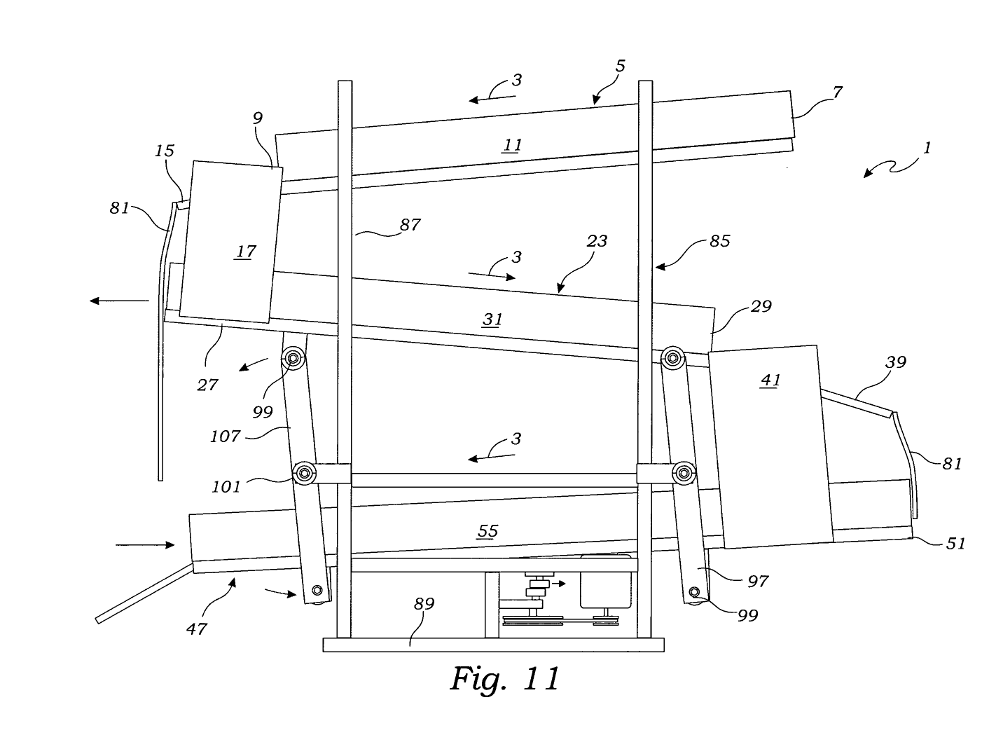

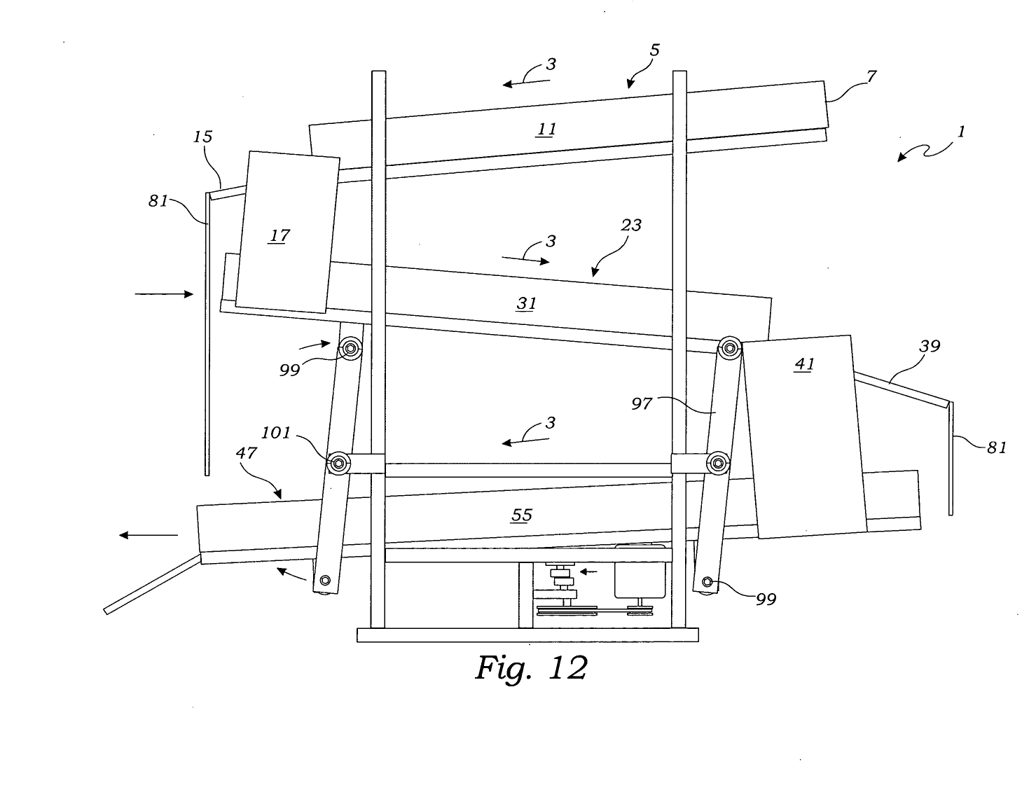

The feed pan 5, top sluice box 23 and bottom sluice deck 47 are positioned within a frame 85 which includes both vertical supports 87 and horizontal supports 89. In addition, the sluice assembly 1 includes an actuator assembly 93 for oscillating the top and bottom sluice boxes in a reciprocating upstream and downstream motion. Preferably, the top and bottom sluice boxes are oscillated at between 150-300 cycles per minute. More preferably, the top and bottom sluice boxes are oscillated at between 200-250 cycles per minute. As but one example that can be devised by one skilled in the art, the actuator assembly 93 includes a linkage assembly 95 and a shaft 105 and motor 107 combination. The linkage assembly includes pivot arms 97 which engage the top and bottom sluice boxes by pivot connections 99. The pivot connections may take the form of bearings or bushings, though it is preferred that low friction bushings are employed. The pivot arms 97, in turn, are connected at or near their midpoints to the frame 85 by frame pivot connections 101 which are also preferably non-friction bushings. With reference to FIGS. 2 and 10-12, rotation of the pivot arms 97 about the frame pivot connections 101 causes the top and bottom sluice boxes 23 and 47 to move either upstream or downstream of the slurry's direction of flow 3. For example, as illustrated in FIG. 11, rotation of the pivot arms in a counterclockwise direction (as seen in the figure) causes the top sluice box 23 to move in an upstream direction and the bottom sluice box 47 to also move in an upstream direction. Conversely, as illustrated in FIG. 12, rotation of the pivot arms 97 in a clockwise direction (as seen in the figure) causes the top sluice box 23 and bottom sluice box 47 to both move in a downstream direction.

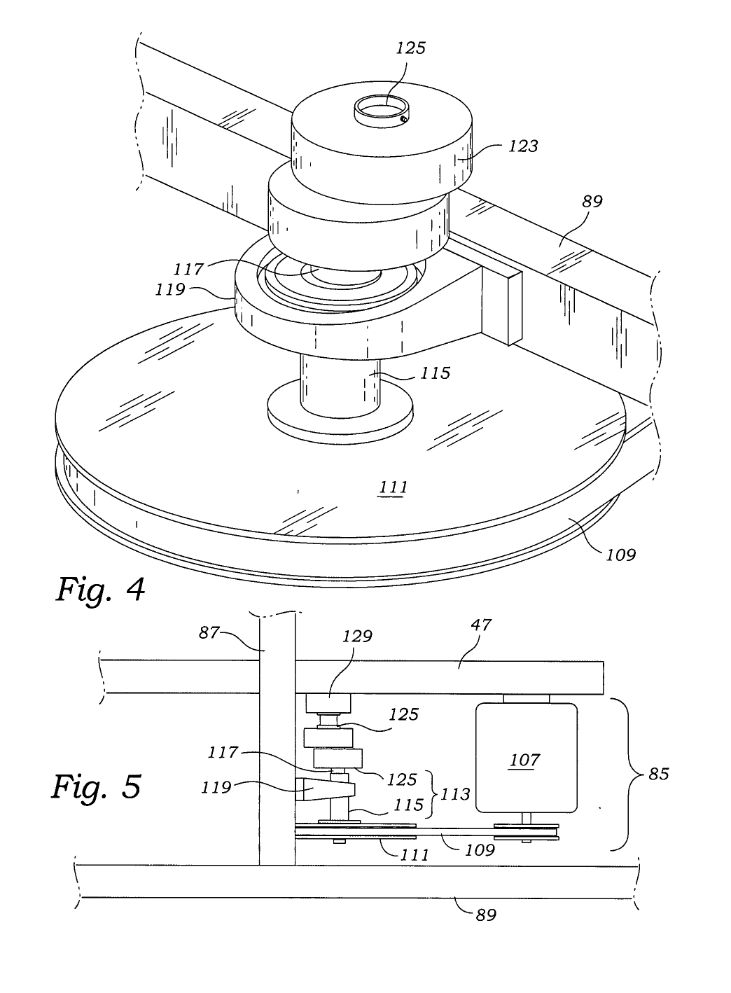

The oscillation of the sluice boxes is controlled by shaft 105 and motor 107 illustrated in FIGS. 4 and 5. The motor may take various forms including those powered by hydrocarbon fuel, electricity or even water. The motor is connected to a reduction wheel 111 by a belt 109. In turn, the reduction wheel rotates the crankshaft 113. To provide a reciprocating motion, the crankshaft 113 includes a main shaft portion 115 and an offset shaft portion 117. In a preferred embodiment, the main shaft portion is 2″ in diameter, the offset shaft portion has a 1½″ diameter which projects upwardly from the top of the main shaft portion 115. The center of the offset shaft portion is not positioned concentric with the midpoint of the main shaft. In a preferred embodiment, the center of the offset shaft portion is ¼″ offset from the center of the main shaft portion so that as the crankshaft 113 is rotated within a shaft support 119, the offset shaft portion is caused to move in a reciprocating upstream and downstream motion a total of ½″.

As illustrated in the figures, the top of the offset shaft 117 is connected to the bottom sluice box 47 by a collar assembly 23. The collar assembly includes top and bottom pivot attachments 125 which again take the form of bushings or bearings. Preferably, the collar's upper and lower pivot attachments 25 are laterally offset by a distance of 1″. As would be understood by those skilled in the art, the ¼″ radial offset of the main shaft 115 to the offset shaft 117 and 1″ offset of the collar pivot attachments causes the top and bottom sluice boxes to accelerate greater when moving in an upstream direction than in a downstream direction. This in turn causes heavier particles to be propelled through the sluice assembly in a downstream direction.

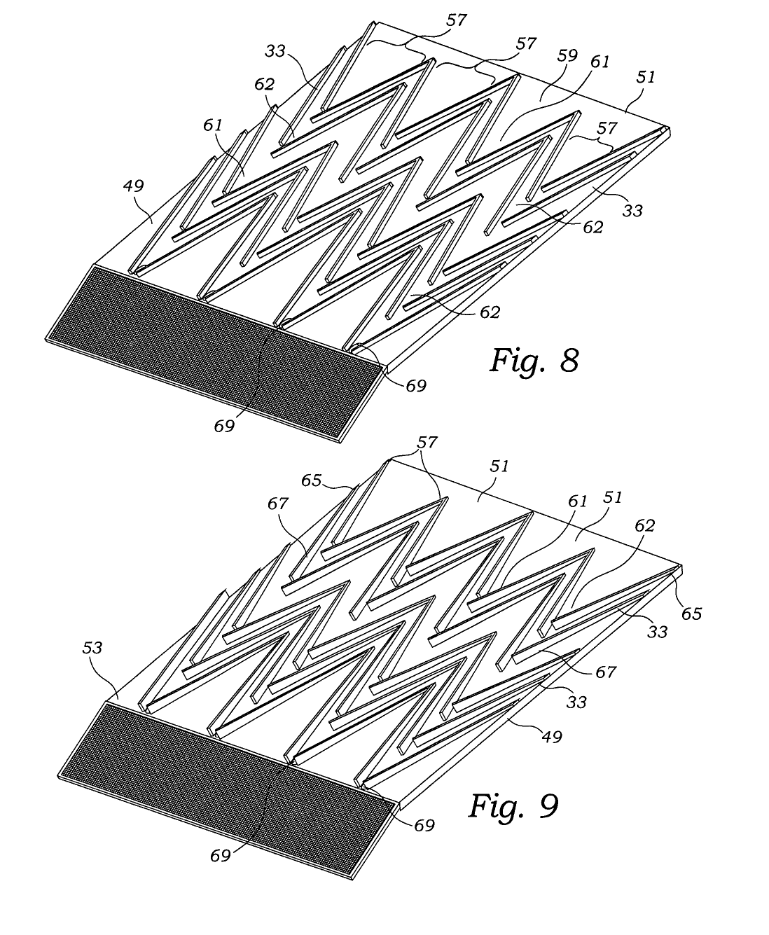

Preferably, the sluice assembly 1 includes riffles formed on the top of the sluice box decks. As shown in FIGS. 8 and 9, preferably the bottom deck 49 includes riffles which are arranged to provide a plurality of “V” shaped diverters in which the open end of each “V” is positioned upstream of the narrow end. Moreover, preferably each “V” shaped diverter 57 includes an opening 59 at its downstream end. As illustrated in FIGS. 8 and 9, slurry traveling atop the deck 49 from the deck's upstream end 51 to the downstream end 53 passes either over the riffles 33 or the heavier materials within the slurry are diverted by the “V” shaped diverters so as to pass through the open ends 59. As illustrated, the open ends 59 of the “V” shaped diverters are positioned upstream to holes 69 formed at the downstream end of the bottom deck 49. Heavier minerals and gemstones diverted by the “V” shaped diverters 57 then pass through the holes 69 so as to be collected for further processing. Conversely, lighter materials are carried by the slurry over the riffles 33 until eventually flowing over the end of the bottom deck 49.

The riffles 33 may incorporate various constructions. In a preferred embodiment, the riffles are made of the same materials as the underlying deck materials. Accordingly, in a preferred embodiment the riffles are made of Tivar® 1000. Also illustrated in FIG. 8, the riffles may have a rectangular or square construction of ¾″×¾″. In an alternative embodiment illustrated in FIG. 9, the riffles are tapered from their downstream ends 67 to their upstream ends 65. In a preferred embodiment, the riffles have a thickness of ¾″, and a height that tapers from ¾″ at their downstream ends 67 to ¼″ at their upstream ends 65. The tapered riffle construction is considered preferable when attempting to collect particles of a lower specific gravity. Accordingly, the deck illustrated in FIG. 9 including tapered riffles is considered ideal for collecting diamonds through holes 69 which have a specific gravity greater than 3.

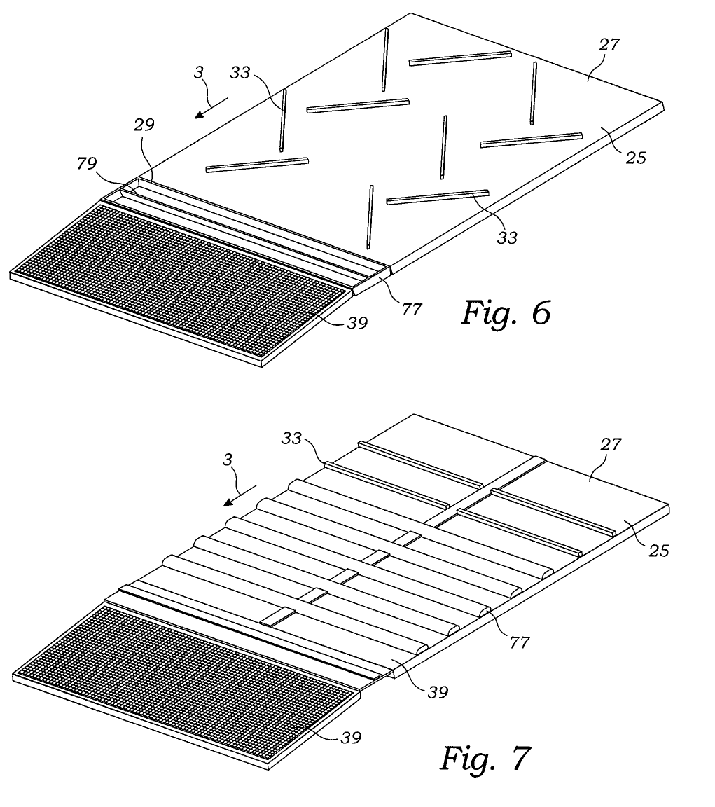

With reference to FIGS. 6 and 7, preferably the deck 25 of the upper sluice box also includes a plurality of riffles 33. In a first embodiment illustrated in FIG. 6, the riffles are positioned to extend downstream and laterally to the direction of slurry flow. This angled riffle construction is considered ideal to cause turbulent flow within the slurry to mix the material and cause solids to mix into a liquid suspension. Heavier materials are separated within the liquid suspension due to the gravity and are forced downstream due to the oscillation of the deck.

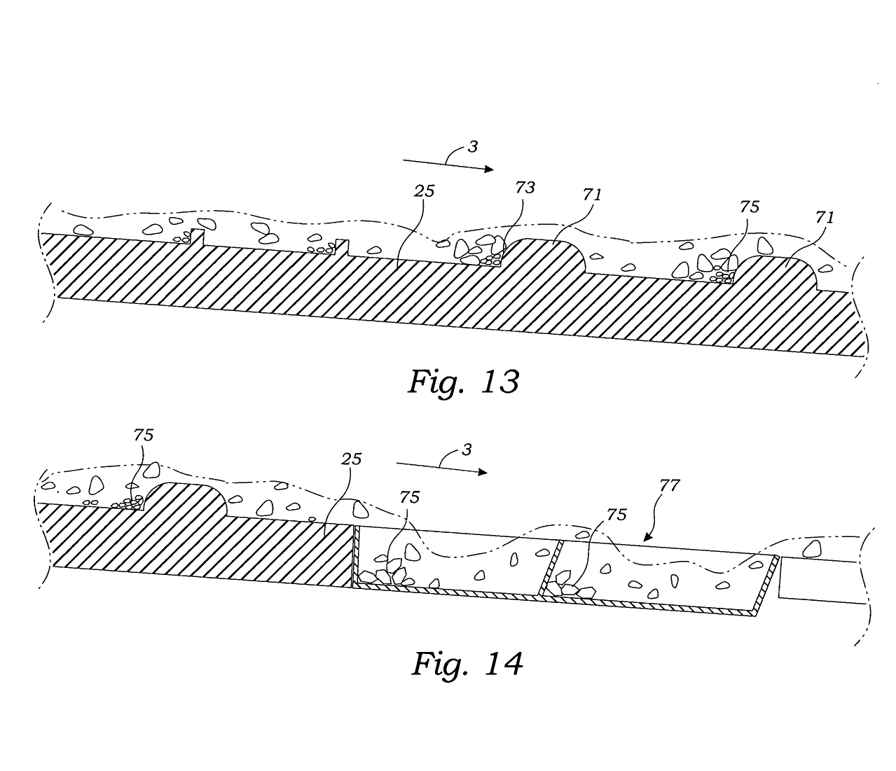

In an alternative embodiment illustrated in FIGS. 7 and 13, the riffles 71 are sized and positioned to extend laterally at an angle of 90° to the direction of slurry flow 3. Upstream riffles 33 provide initial mixing of the slurry in an effort to mix minerals and gemstones into a liquid suspension. The downstream riffles 31 are constructed to collect heavier materials having a specific-gravity greater than a predetermined amount. With reference to FIG. 7, the laterally extending riffles 71 are spaced at intervals of 12″ and have a height of 1″ and thickness of 1½″. In operation, as slurry is moved downstream, heavier particles 75 are moved downstream due to oscillation of the top deck 49 until engaging the riffles 31. In the event the particles are greater than a specific gravity of 3, the heavier particles will tend to rest in the inner section 33 of the riffles and deck without flowing over the riffles. The heavier particles 75 can then be collected manually or mechanically.

Various modifications of the invention can be made. For example, the user of the sluice assembly may wish to include a nugget trap 77 shown in FIGS. 6 and 14. Preferably, the nugget trap is positioned immediately downstream of the top sluice box's deck 25 so that slurry flowing from the top deck will flow into the nugget trap 77 before then flowing through the classifying screen 39. Though not illustrated in the figures, preferably the nugget trap is positioned immediately downstream of the top deck 25, but instead of being affixed to the top sluice box, the nugget trap 77 is mechanically linked to the bottom sluice box 47 so that the nugget trap will move in an upstream direction when the sluice boxes are moving in a downstream direction. By affixing the nugget trap to the bottom sluice box, but positioning it adjacent and immediately downstream to the top sluice box, causes particles within the nugget trap to move upstream, as illustrated in FIG. 14.

Still additional modifications of the invention can be made without departing from the spirit and scope of the invention. For example, the sluice assembly 1 may be constructed with various dimensions. A preferred construction is 8′ wide across the direction of slurry flow and 9′ long with the direction of slurry flow. Additional preferred constructions are 4′ wide and 9′ long; 3′ wide and 6′ long; and 6′ wide and 9′ long. Various slurry flow rates may be employed. However, it has been found that the 8′ wide and 9′ long construction can handle 1,200-1,600 gallons of water per minute in which the upper sluice box processes approximately 400 cubic yards of material per hour and the bottom sluice box processes 100-150 cubic yards of material per hour.

While several particular forms of the invention have been illustrated and described, it will be apparent that various modifications can be made without departing from the spirit and scope of the invention. Accordingly, it is not intended that the invention be limited except by the following claims.

1. A sluice assembly for separating heavy particles from slurry comprising:
a sluice box for receiving a slurry, said sluice box having sidewalls and a sloping deck defining an upstream end, a downstream end and a direction of slurry flow, said sloping deck made of plastic having a Shore D hardness between 50 and 75, an ASTM-D1894 calculated static coefficient of friction less than 0.3 and a kinetic coefficient of friction less than 0.2;
a plurality of riffles projecting upward from said deck and extending at least partially laterally across the direction of slurry flow; and
an actuator means engaging said sluice box for oscillating said sluice box in a reciprocating upstream and downstream motion.

2. The sluice assembly for separating heavy particles from slurry of claim 1 wherein said deck is made of ultra high molecular weight (UHMW) plastic.

3. The sluice assembly for separating heavy particles from slurry of claim 1 wherein said deck is made of plastic having a Shore D hardness between 64 and 70, an ASTM-D 1894 calculated static coefficient of friction less than 0.26 and a kinetic coefficient of friction less than 0.15.

4. The sluice assembly for separating heavy particles from slurry of claim 1 wherein said deck is made of Tivar® plastic having a Shore D hardness between 64 and 70, and an ASTM-D1894 calculated static coefficient of friction less than 0.26 and a kinetic coefficient of friction less than 0.15.

5. A dual deck sluice assembly for separating heavy particles from slurry comprising:
a first sluice box for receiving a slurry, said first sluice box having sidewalls and a sloping first deck defining an upstream end, a downstream end and a direction of slurry flow, said sloping first deck made of plastic having a Shore D hardness between 50 and 70, an ASTM-D1894 calculated static coefficient of friction less than 0.3 and a kinetic coefficient of friction less than 0.2;
a first set of a plurality of riffles projecting upward from said first deck and extending at least partially laterally across the direction of slurry flow; and
a second sluice box positioned below said first sluice for receiving a slurry from said first sluice box, said second sluice box having sidewalls and a sloping second deck defining an upstream end, a downstream end and a direction of slurry flow, said sloping second deck made of plastic having a Shore D hardness between 50 and 75, an ASTM-D1894 calculated static coefficient of friction less than 0.3 and a kinetic coefficient of friction less than 0.2;
a second set of a plurality of riffles projecting upward from said second deck and extending at least partially laterally across the direction of slurry flow; and
an actuator means engaging said first and second sluice boxes for oscillating said sluice boxes in a reciprocating upstream and downstream motion wherein movement of said first sluice box in a direction causes said second sluice box to move in an opposite direction.

6. The dual deck sluice assembly for separating heavy particles from slurry of claim 5 wherein said first and second decks are made of ultra high molecular weight (UHMW) plastic.

7. The dual deck sluice assembly for separating heavy particles from slurry of claim 5 wherein said first and second decks are made of plastic having a Shore D hardness between 64 and 70, an ASTM-D 1894 calculated static coefficient of friction less than 0.26 and a kinetic coefficient of friction less than 0.15.

8. The dual deck sluice assembly for separating heavy particles from slurry of claim 5 wherein said first and second decks are made of Tivar® plastic having a Shore D hardness between 64 and 70, and an ASTM-D 1894 calculated static coefficient of friction less than 0.26 and a kinetic coefficient of friction less than 0.15.

9. A dual deck sluice assembly for separating heavy particles from slurry comprising:
a first sluice box for receiving a slurry, said first sluice box having sidewalls and a sloping first deck defining an upstream end, a downstream end and a direction of slurry flow;
a first set of a plurality of riffles projecting upward from said first deck, said first set of riffles extending at least partially laterally across the direction of slurry flow; and
a second sluice box positioned below said first sluice for receiving a slurry from said first sluice box, said second sluice box having sidewalls and a sloping second deck defining an upstream end, a downstream end and a direction of slurry flow, said second sluice box including one or more holes for located toward the second sluice box's downstream end for collection of heavy particles;
a second set of a plurality of riffles projecting upward from said second deck, said second set of riffles arranged to provide a plurality of “V” shaped diverters having an open end and a narrow end, said “V” shaped diverters positioned so that the open ends are upstream to the narrow ends and the narrow ends are directly upstream of said one or more holes for diverting heavy particles within said slurry to said one or more holes, said riffles of a height sufficiently low as to allow particles of a predetermined specific gravity to flow over said riffles so as to avoid said holes, but said riffles of a height sufficiently high to divert particles of a predetermined specific gravity toward and into said holes;
one or more collectors positioned below said one or more holes for collecting heavy particles that fall through said one or more holes;
an actuator means engaging said first and second sluice boxes for oscillating said sluice boxes in a reciprocating upstream and downstream motion wherein movement of said first sluice box in a direction causes said second sluice box to move in an opposite direction.

10. The dual deck sluice assembly for separating heavy particles from slurry of claim 9 wherein said first and second decks are made of plastic having a Shore D hardness between 64 and 70, an ASTM-D 1894 calculated static coefficient of friction less than 0.26 and a kinetic coefficient of friction less than 0.15.

11. The dual deck sluice assembly for separating heavy particles from slurry of claim 9 wherein said first and second decks are made of ultra high molecular weight (UHMW) plastic.

12. The dual deck sluice assembly for separating heavy particles from slurry of claim 9 wherein said first and second decks are made of Tivar® plastic having a Shore D hardness between 64 and 70, and an ASTM-D 1894 calculated static coefficient of friction less than 0.26 and a kinetic coefficient of friction less than 0.15.

13. The dual deck sluice assembly for separating heavy particles from slurry of claim 9 wherein said second set of riffles having a tapered height in which the height of said riffles increases from their upstream ends to their downstream ends.

14. The dual deck sluice assembly for separating heavy particles from slurry of claim 13 wherein said second set of riffles having a tapered height in which the height of said riffles increases from upstream ends having a height of about ¼ inch to their downstream ends having a height of about ¾ inch.

15. The dual deck sluice assembly for separating heavy particles from slurry of claim 9 wherein said first set of riffles extend at laterally across the first deck at an angle of 90° to the direction of slurry flow so as to engage and prevent further downstream movement of heavy particles having a specific gravity greater than a predetermined value within a slurry to allow collection of heavy particles engaging said first set of riffles.

16. The dual deck sluice assembly for separating heavy particles from slurry of claim 15 wherein said first set of riffles are constructed of a height to collect particles having a specific gravity greater than 3.

17. The dual deck sluice assembly for separating heavy particles from slurry of claim 16 wherein said second set of riffles having a tapered height in which the height of said riffles increases from upstream ends to their downstream ends.

18. The dual deck sluice assembly for separating heavy particles from slurry of claim 16 wherein said second set of riffles having a tapered height in which the height of said riffles increases from upstream ends having a height of about ¼ inch to their downstream ends having a height of about ¾ inch.

19. The dual deck sluice assembly for separating heavy particles from slurry of claim 15 wherein said first and second decks are made of plastic having a Shore D hardness between 64 and 70, an ASTM-D 1894 calculated static coefficient of friction less than 0.26 and a kinetic coefficient of friction less than 0.15.

20. The dual deck sluice assembly for separating heavy particles from slurry of claim 16 wherein said first and second decks are made of Tivar® plastic having a Shore D hardness between 64 and 70, and an ASTM-D 1894 calculated static coefficient of friction less than 0.26 and a kinetic coefficient of friction less than 0.15.
